(19) United States
(12) Patent Application Publication
(10) Pub. No.: US 2008/0136708 A1
(43) Pub. Date: Jun. 12, 2008

(54) USN SYSTEM USING MULTI-CHANNEL HAVING DIFFERENTIAL RADIO POWER AND METHOD OF CONFIGURING THE SYSTEM

(75) Inventors: Se Han Kim, Daejeon-city (KR); Ji Eun Kim, Daejeon-city (KR); Nae Soo Kim, Daejeon-city (KR); Cheol Sig Pyo, Daejeon-city (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Electronics and Telecommunications Research Institute, Daejeon-city (KR)

(21) Appl. No.: 11/932,968

(22) Filed: Oct. 31, 2007

(30) Foreign Application Priority Data
Dec. 7, 2006 (KR) 10-2006-0124153

(51) Int. Cl. H04B 7/00; H04L 12/56

(52) U.S. Cl. 342/367

(57) ABSTRACT

A Ubiquitous Sensor Network (USN) system using multi-channel having differential radio power and a method of configuring the USN system are provided. The USN system and the method include a sink node performing a communication with a sensor node using at least one or more frequency signal having differential outputs; and a sensor node performing the communication with the sink node using the at least one or more frequency signal. The USN system and the method simultaneously use a control frequency signal having a high output power and a data frequency signal having an output power lower than that of the control frequency signal, thereby reducing a beacon transmission delay, enabling time synchronization between the sensor nodes, and preventing collisions between beacons due to beacon relays among the sensor nodes, so as to configure a more efficient sensor field.

### CROSS-REFERENCE TO RELATED PATENT APPLICATION

This application claims the benefit of Korean Patent Application No. 10-2006-0124153, filed on Dec. 7, 2006, in the Korean Intellectual Property Office, the disclosure of which is incorporated herein in its entirety by reference.

### BACKGROUND OF THE INVENTION

1. Field of the Invention

The present invention relates to a Ubiquitous Sensor Network (USN) system using multi-channel having differential radio power and a method of configuring the USN system, and more particularly, to a USN system using two channels that are a control channel having a high output power and a data channel having a low output power, and a method of configuring the USN.

The present invention is supported by an information technology (IT) research and development (R&D) program of Ministry of Information and Communication (MIC)/Institute for Information Technology Advancement (IITA) [2005-S-106-02, “Development of Sensor Tag and Sensor Node Technologies for RFID/USN”].

2. Description of the Related Art

A Ubiquitous Sensor Network (USN) is a network system which configures a wireless sensor network via a sensor node having a sensor capable of sensing cognitive information from objects, or environmental information from surroundings, and then processes and manages the sensed information via various sensors, by being connected to the outside via a network in real-time. Ultimately, the purpose of a USN is to provide computing and communication functions to all objects, so as to realize an environment in which communication is possible anytime and anywhere, regardless of a network, a device or a service.

FIG. 1 is a diagram illustrating a configuration of a conventional USN.

Referring to FIG. 1, the conventional USN may include a sensor node 110, a sensor field 120, a sink node 130, and a gateway 140. The sensor node 110 includes a sensor that in real-time senses cognitive information from objects or environmental information from surroundings, and a communication module. The sensor field 120 is formed of a plurality of the sensor node 110. The sink node 130 receives information collected in the sensor field 120. The gateway 140 routes the information transmitted from the sink node 130, and then sends the information to a management server 150 via a broadband communication network. In the aforementioned configuration, the sink node 130 may be connected to the gateway 140 via a conventional infrastructure such as a satellite communication, a wireless local area network, Bluetooth, a wired Internet connection, or the like.

In this configuration, one sink node is responsible for one sensor field. At this time, in order to efficiently manage power of respective sensor nodes, a medium access control (MAC) protocol is configured so as to minimize the power consumed by the sensor nodes during an inactive period that is an unused period, and to use the power only during an active period. At this time, the sink node 130 informs the plurality of the sensor node 110 in the sensor field 120 of the active period and the inactive period via a beacon that is a control packet.

FIG. 2A is a diagram illustrating a conventional configuration of a sensor field in the case where one frequency is used. FIG. 2B is a diagram illustrating a data stream in a single-channel CH-1 used in the configuration of the sensor field illustrated in FIG. 2A.

Referring to FIG. 2A, the sensor field includes a packet transmission range 201 of a sink node 202, packet transmission ranges 203 and 206 of a node-1 204 and a node-2 205, respectively, which are middle nodes, and packet transmission ranges 209 and 210 of a node-3 207 and a node-4 208, respectively. The sink node 202 divides a period into an active period and an inactive period, and then transmits a beacon packet to the node-1 204, the node-2 205, the node-3 207, and the node-4 208 so that transmission/reception of data can be performed during the active period. As illustrated in FIG. 2B, the beacon packet and data are transmitted via the single channel CH-1. In the configuration illustrated in FIG. 2A, in order for the sink node 202 to transmit the beacon packet to the node-3 207 and the node-4 208, it is possible only via a relay by the node-1 204 and the node-2 205. In the case where the beacon is delivered to the node-3 207 and the node-4 208 via relay by the node-1 204 and the node-2 205, a beacon transmission delay occurs. In particular, a considerable delay occurs in an initial form in which the sensor field is configured. Also, in the case where the number of hops increases due to many nodes, the beacon transmission delay from a sink node to an end-node increases significantly, causing sink problems between nodes whereby data transmission becomes impossible in an urgent circumstance.

In brief, when a beacon is transmitted from a sink node to a sensor node, an interval between an active period and an inactive period within the beacon is determined, and when the active period starts, all nodes have to become active simultaneously, and receive the beacon. That is, when the sink node starts transmitting the beacon, all sensor nodes in a sensor field have to become active simultaneously. For this purpose, time synchronization between all the sensor nodes has to be performed. However, when a beacon is relayed, while passing through several hops in a conventional method, it is difficult to perform time synchronization between all the nodes due to processing time in the nodes.

Also, when a beacon initially transmitted from the sink node passes through the nodes, many overlapped beacons are generated as a result of passing through middle nodes and being relayed by the nodes, thereby causing collisions between the beacons.

### SUMMARY OF THE INVENTION

To solve the aforementioned problems, the present invention provides a Ubiquitous Sensor Network (USN) system using multi-channel having differential radio power and a method of configuring the USN system. The USN system differentiates a control frequency for controlling a sensor field such as a beacon packet, and a data frequency for a data channel. At the same time, the USN system controls the control frequency to be greater than the data frequency so that the control frequency can control a wider area at a time. Accordingly, in the case where a beacon is relayed via sensor nodes, the USN system can reduce a beacon transmission delay which increases in proportion to the number of sink nodes and hops.

According to an aspect of the present invention, there is provided a Ubiquitous Sensor Network (USN) system using multi-channel having differential radio power, the system including: a sink node performing a communication with a sensor node using at least one or more frequency signal having differential outputs; and a sensor node performing the communication with the sink node using the at least one or more frequency signal.

The sink node includes a first output unit outputting control data having a control channel frequency for controlling the sensor node, and a second output unit having a data channel frequency for exchanging data with the sensor node.

According to another aspect of the present invention, there is provided a method of configuring a USN with a sink node and at least one or more sensor node wherein the USN uses multi-channel having differential radio power, the method including the operations of determining a type of data that is to transmitted to a sensor node; outputting data via a first output channel, when the data is for controlling the at least one or more sensor node; and outputting data via a second output channel having a frequency different from that of the first output channel, when the data is not the control data.

To achieve the above-described purposes, the USN system according to the present invention has a hardware configuration that can simultaneously use two channels. The two channels are a control channel having a high output power for transmitting a beacon, and a data channel having a low output power for transmitting data.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating a configuration of a conventional USN;

FIG. 2A is a diagram illustrating a conventional configuration of a sensor field in the case where one frequency is used;

FIG. 2B is a diagram illustrating a data stream in a single-channel used in the configuration of the sensor field illustrated in FIG. 2A;

FIG. 3 is a diagram illustrating a configuration of a transmission apparatus having two output interfaces according to an embodiment of the present invention;

FIG. 4A is a diagram illustrating a configuration of a sensor field in which two frequencies having differential output power are used according to an embodiment of the present invention;

FIG. 4B is a diagram illustrating a data stream in multi-channel used in the configuration of the sensor field shown in FIG. 4A, according to an embodiment of the present invention; and

FIG. 5 is a flowchart illustrating a method of configuring a Ubiquitous Sensor Network (USN) using multi-channel having differential radio power, according to an embodiment of the present invention.

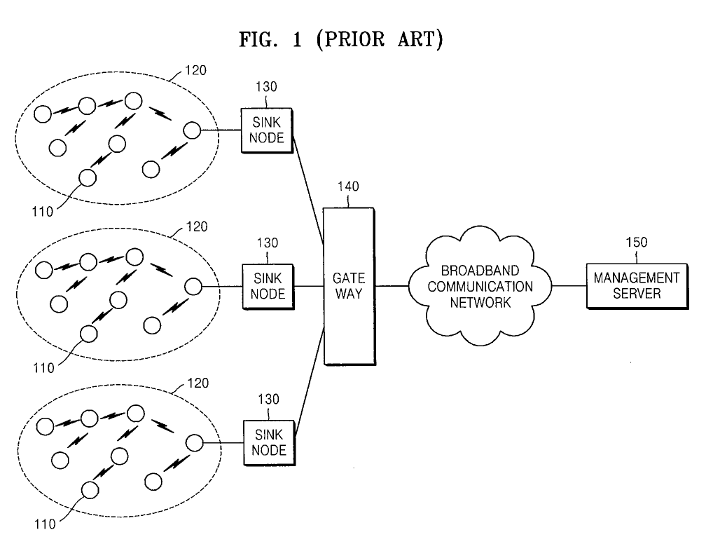

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art.

Functions of various devices that are illustrated in drawings including a function block denoted as a processor or as a similar concept with the processor, can be provided not only with specific hardware but also general hardware in which related software may be executed. When these functions are provided by the processor, the functions may be provided by a singular specific processor, a singular sharable processor, or plural processors in which sharing between the plural processors is possible. Also, usage of terms such as a processor, a control, or the like should not be construed as being limited to hardware capable of executing software but should be construed as indirectly including digital signal processor (DSP) hardware, read-only memory (ROM), random-access memory (RAM), and non-volatile memory used for storing software. Other well-known conventional hardware devices may be included.

Hereinafter, the present invention will be described in detail by explaining exemplary embodiments of the invention with reference to the attached drawings. In the following description, well-known functions or constructions are not described in detail since they would obscure the invention with unnecessary detail.

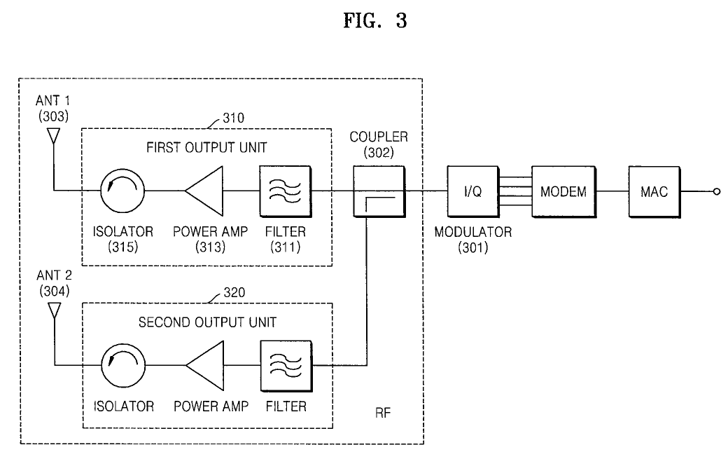

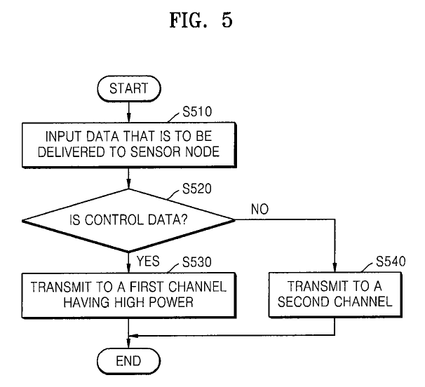

FIG. 3 is a diagram illustrating a configuration of a transmission apparatus having two output interfaces according to an embodiment of the present invention. FIG. 5 is a flowchart illustrating a method of configuring a Ubiquitous Sensor Network (USN) using multi-channel having differential radio power, according to an embodiment of the present invention.

Referring to FIGS. 3 and 5, when data that is to be delivered to a sensor node, is input to the transmission apparatus illustrated in FIG. 3 in operation 510, a modulator 301 receives the data output from a converter of a digital conversion unit, and then modulates the data into a radio frequency (RF) signal. In operation 520, a coupler 302 determines whether the RF signal is control data. Then, the coupler 302 selects an output direction for the RF signal according to output power. That is, in operations 530 through 540, when the modulated RF signal is the control data, the coupler 302 delivers the modulated RF signal to a first output unit 310 which outputs data via a first channel having high output power. However, when the modulated RF signal is a general data signal, the coupler 302 delivers the modulated RF signal to a second output unit 320 which outputs data via a second channel having low output power. A filter 311 removes spurious components outside a transmission band. A power amplifier 313 amplifies a signal that is to be transmitted. In the case where an antenna is not connected to an output of a RF unit, an isolator 315 prevents the RF unit from being disabled by a reflection wave reflected from the signal. Antennas ‘1’ 303 and ‘2’ 304 radiate the modulated RF signal to free space. Here, the antennas ‘1’ 303 and 304 are selected according to output power via power amplifiers.

The transmission apparatus includes the first output unit 310 and the second output unit 320 as illustrated in FIG. 3. The above description is based on the first output unit 310. However, since a function of the second output unit 320 is the same as the first output unit 310, the description related to the function of the second output unit 320 is omitted. In brief, the first output unit 310 outputs control data having a control channel frequency for controlling a sensor node, and the second output unit 320 outputs general data having a data channel frequency for exchanging data with the sensor node. The output power of a signal having the control channel frequency is greater than an output power of a signal having the data channel frequency, and the output power of the signal having the control channel frequency may cover an entire area of a sensor field.

Also, the control data is mainly a broadcast packet or a command packet.

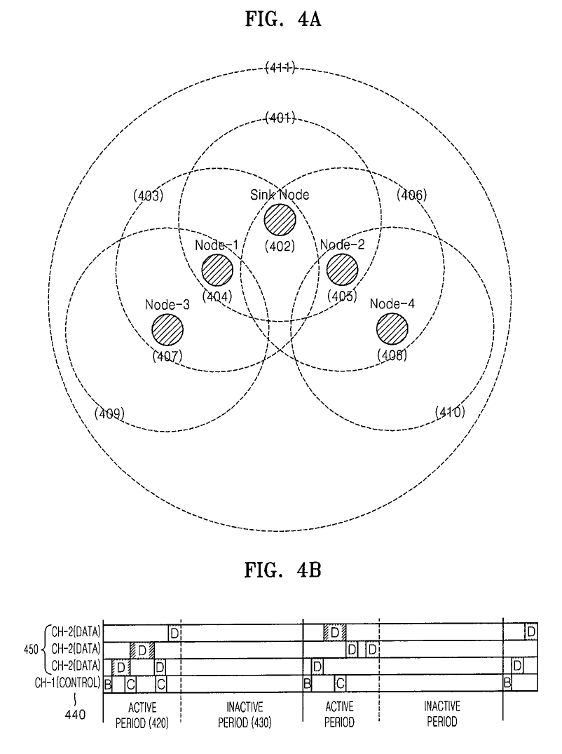

Referring to FIGS. 4A through 4B, the operation of the USN system operated using the multi-channel according to the present invention is described again.

FIG. 4A is a diagram illustrating a configuration of a sensor field in which two frequencies having differential output power are used according to an embodiment of the present invention. FIG. 4B is a diagram illustrating a data stream in multi-channel used in the configuration of the sensor field shown in FIG. 4A, according to an embodiment of the present invention.

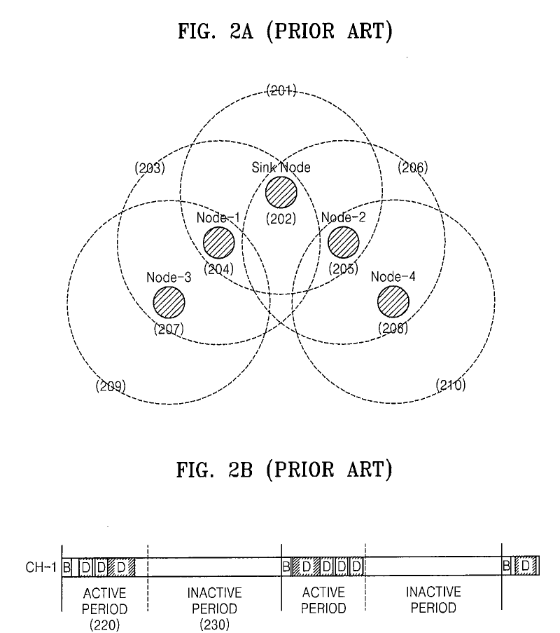

Referring to FIG. 4A, the sensor field according to the current embodiment of the present invention includes a transmission range 411 of a control channel from which a sink node 402 transmits a beacon, and a transmission range 401 of a data channel from which general data is transmitted. The sensor field also includes transmission ranges 403 and 406 of a node-1 404 and a node-2 405 which are middle nodes, respectively, and transmission ranges 409 and 410 of a node-3 407 and a node-4 408, respectively. General sensor nodes which are not a sink node, have only one interface having the same output power as the data channel of the sink node. The sink node 402 divides a period into an active period 420 and an inactive period 430, and then transmits a beacon packet to the node-1 404, the node-2 405, the node-3 407, and the node-4 408 so that transmission/reception of data can be performed during the active period 420. As illustrated in FIG. 4B, the beacon packet and data are transmitted via the multi-channel. In the configuration illustrated in FIG. 2A, in order for the sink node 202 to transmit a beacon packet to the node-3 207 and the node-4 208, it is possible only via a relay by the node-1 204 and the node-2 205. However, unlike the configuration illustrated in FIG. 2A, in the configuration illustrated in FIG. 4B according to the current embodiment of the present invention, the beacon packet is delivered simultaneously to each of the node-1 404, the node-2 405, the node-3 407, and the node-4 408 without passing through a separate relay. A channel-1 440 illustrated in FIG. 4B is used to transmit a control beacon packet, a broadcast packet, and a command packet. The broadcast packet and the command packet are to be transmitted to all of the nodes in the sensor field. A data exchange using a channel-2 450 is performed by a contention method that is a carrier sense multiple access/collision avoidance (CSMA/CA) method, or by a time division multiple access (TDMA) method between the nodes.

The USN system using the multi-channel having the differential radio power and the method of configuring the USN system according to the present invention are described above. The USN system and the method are used to configure a sensor field by using two interfaces having differential outputs in a sink node. More specifically, the USN system and the method simultaneously use a control frequency signal having a high output power and a data frequency signal having an output power lower than that of the control frequency signal, thereby reducing a beacon transmission delay, enabling time synchronization between the sensor nodes, and preventing collisions between beacons due to beacon relays among the sensor nodes, thereby obtaining a more efficient sensor field.

Eventually, when data is transmitted from a sensor node to a sink node via a data channel having lower power than a beacon channel, the USN System and the method obtain a more efficient senser field.

A method of configuring a USN system using multi-channel having differential radio power according to the present invention can also be embodied as computer readable codes on a computer readable recording medium. The computer readable recording medium is any data storage device that can store programs or data which can be thereafter read by a computer system. Examples of the computer readable recording medium include read-only memory (ROM), random-access memory (RAM), CD-ROMs, magnetic tapes, hard disks, floppy disks, flash memory, optical data storage devices, and carrier waves (such as data transmission through the Internet). The computer-readable recording medium can also be distributed over computer systems which are coupled with computer communication networks so that the computer-readable code is stored and executed in a distributed fashion. Also, a font, read-only memory(ROM), and data structure according to the present invention can be embodied as computer readable codes on a computer readable recording medium including read-only memory (ROM), random-access memory (RAM), CD-ROMs, magnetic tapes, hard disks, floppy disks, flash memory, and optical data storage devices.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A Ubiquitous Sensor Network (USN) system using multi-channel having differential radio power, the system comprising:
a sink node performing a communication with a sensor node using at least one or more frequency signal having differential outputs; and
a sensor node performing the communication with the sink node using the at least one or more frequency signal.

2. The USN system of claim 1, wherein the sink node comprises:
a first output unit outputting control data having a control channel frequency for controlling the sensor node; and
a second output unit having a data channel frequency for exchanging data with the sensor node.

3. The USN system of claim 2, wherein an output power of a signal having the control channel frequency is greater than an output power of a signal having the data channel frequency.

4. The USN system of claim 2, wherein the control data is one of a broadcast packet and a command packet.

5. The USN system of claim 3, wherein the output power of the signal having the control channel frequency covers an entire area of a sensor field that the sink node controls.

6. The USN system of claim 2, wherein the sink node further comprises a coupler connecting data to the first output unit whereby the data is transmitted to the sink node when the data is control data, the coupler connecting data to the second output unit whereby the data is transmitted to the sink node when the data is general data.

7. The USN system of claim 1, wherein the sensor node competes with other sensor nodes in the sensor field that the sink node controls, and obtains a priority using a Carrier Sense Multiple Access/Collision Avoidance (CSMA/CA) method.

8. The USN system of claim 1, wherein the sensor node performs a data communication with other sink node in the sensor field that the sink node controls, using a Time Division Multiple Access (TDMA) method.

9. A method of configuring a USN with a sink node and at least one or more sensor node wherein the USN uses multi-channel having differential radio power, the method comprising:
determining a type of data that is to transmitted to a sensor node;
outputting data via a first output channel, when the data is for controlling the at least one or more sensor node; and
outputting data via a second output channel having a frequency different from that of the first output channel, when the data is not the control data.

10. The method of claim 9, wherein the first output channel has an output power greater than that of the second output channel.

11. The method of claim 10, wherein the first output channel has an output power capable of covering an entire area of a sensor field that the sink node controls.

12. The method of claim 10, wherein the control data is one of a broadcast packet and a command packet.
